(19) United States
(12) Patent Application Publication
(10) Pub. No.: US 2005/0236824 A1
(43) Pub. Date: Oct. 27, 2005

(54) Vehicle leveling system and method using a combination outrigger and jack mount

(76) Inventors: Reid L. Wissler, Brownstone, PA (US); James A. Salmi, Lititz, PA (US)

Correspondence Address: FOSTER, SWIFT, COLLINS & SMITH, P.C., 313 SOUTH WASHINGTON SQUARE, LANSING, MI, 48933, US

(21) Appl. No.: 10/828,770

(22) Filed: Apr. 21, 2004

(51) Int. Cl. B60S 9/02

(52) U.S. Cl. 280/765.1

(57) ABSTRACT

An assembly adapted for use in an outrigger device for stabilizing a work vehicle such as a fire truck includes an elongated housing having an open end and adapted to be pivotally attached to the vehicle. An extendible-retractable beam is telescopically fitted in the housing and can be hydraulically extended and retracted. A jack tower is affixed to the outer end of the beam at an angle offset from the perpendicular. The jack tower includes a first component affixed to the beam and a second extendible retractable component telescopically affixed to the first component, and a hydraulic actuator for extending and retracting the second component which preferably has a ground-engaging pad pivotally attached to its lower end.

### BACKGROUND OF THE INVENTION

1. Field of the Invention

The present invention generally relates to vehicle leveling systems and specifically to a vehicle leveling system and method using a combination outrigger and jack mount suitable for aerial ladder mounts.

2. Discussion of Related Art

A common problem with vehicle leveling systems is the lack of range and flexibility needed to deploy a stable vehicle platform in a variety of terrains and topographies. This flexibility often proves critical when the vehicle is a fire truck outfitted with an aerial ladder that must be set-up in emergency conditions.

Early patents such as U.S. Pat. No. 1,155,958 to Rickard disclose firefighting devices that employ retractable rods pushed to the ground to prevent sliding movement of the truck while the aerial ladder is in use. U.S. Pat. No. 4,171,120 to Clark is a lift with a work platform that incorporates a scissor arrangement with outriggers at its base. The outriggers are secured by a link that moves along a track. The lift is also meant to be mobile as it has wheels at the base and outriggers. This design is impractical if it were to be applied to a vehicle because it may allow shifting while in use. Also the outriggers do not help level the machine, but are just to support. As such, it could not be expected to withstand the weight of something much heavier than the platform.

U.S. Pat. No. 5,833,260 to York also employs a scissoring unit for support of a bladder to a vehicle service unit as the bladder inflates; however, the scissoring unit is not attached to the outriggers. The outriggers are hydraulic cylinders that lift and lower the unit. Nevertheless, the outriggers do not work in combination with a scissoring device to aid in leveling.

U.S. Pat. No. 4,834,215 to Smeal has retractable outrigger assemblies extendible to support a moveable frame when the aerial device is in operation. It employs hydraulic cylinders in the outriggers to level the vehicle. It lifts the wheels to allow for movement of the aerial device; however, it neither has a scissoring device to aid in the support of the aerial device nor allows extended range of deployment angles. U.S. Pat. No. 4,941,546 to Nist, et al uses outriggers on one side to stabilize the truck. Its disadvantages are that the device may only stabilize the vehicle platform and ladder when it is deployed to that side. It also has auxiliary jacks to aid in stabilizing the vehicle when there is use of high pressure water from the ladder.

U.S. Pat. No. 4,949,808 to Garnet also uses a similar design but also incorporates hydraulic cylinders to stabilize the aerial device. It would still have the disadvantage of not providing uniform support to both sides or being able to level the vehicle. It also does not employ a scissoring device.

U.S. Pat. No. 6,516,917 to Mayer, employs a scissoring mechanism having a pair of outriggers. Unfortunately, these outriggers have a system of pulleys to position the leg member and a support pad to keep the device in place. This design may not be practical because the pulleys may not be able to withstand the weight of heavy applications such as a fire truck.

While there have been attempts to provide systems to level a vehicle, there remains a desire and need in the art for a vehicle leveling system and method using a combination outrigger and jack mount suitable for aerial ladder mounts. Such application would allow for greater flexibility and therefore greater usefulness of a vehicle over an increased variety to terrain.

### SUMMARY OF THE INVENTION

Accordingly, the present invention provides an improved outrigger assembly for attachment to work vehicles including fire fighting vehicles having aerial ladders mounted thereon.

In one embodiment of the present invention, an assembly adapted for use in an outrigger device for stabilizing a work vehicle such as a fire truck includes an elongated housing having an open end and adapted to be pivotally attached to the vehicle. An extendible-retractable beam is telescopically fitted in the housing and can be hydraulically extended and retracted. A jack tower is affixed to the outer end of the beam at an angle offset from the perpendicular. The jack tower includes a first component affixed to the beam and a second extendible retractable component telescopically affixed to the first component, and a hydraulic actuator for extending and retracting the second component which preferably has a ground-engaging pad pivotally attached to its lower end.

In another embodiment of the present invention an outrigger assembly for stabilizing a vehicle includes a pair of elongated support housings each adapted to be pivotally attached to the vehicle at a pivot point, each adapted to extend toward opposite sides of the vehicle from each other. Each housing has an open end with an extendible-retractable beam telescopically fitted therein. A linear actuator, preferably a double-acting hydraulic cylinder is provided for extending and retracting each beam. A jack tower is affixed to an outer end of each beam, preferably at an oblique angle offset from the perpendicular. The jack tower includes a first component, preferably a hydraulic cylinder affixed to the beam and a second extendible retractable component, preferably a hydraulic piston and rod telescopically fitted in the first component. Independently controllable actuators are provided for extending and restricting the second component, the beam and for pivoting each housing about its pivot point.

Other features of the present invention will become more apparent to persons having ordinary skill in the art to which the present invention pertains from the following description and claims taken in conjunction with the accompanying figures.

### BRIEF DESCRIPTION OF THE FIGURES

The foregoing features, as well as other features, will become apparent with reference to the description and figures below, in which like numerals represent like elements, and in which:

FIG. 1 is a bottom perspective view of an embodiment of the present invention;

FIG. 2 is a side view of the present invention;

FIG. 3 is an end view of the present invention;

FIG. 4 is a top view of the present invention;

FIG. 5 is a side view of the present invention installed on a fire truck;

FIG. 6 is a side perspective view of the present invention with a mounted aerial ladder;

FIG. 7 is a top perspective view of the present invention with a mounted aerial ladder;

FIG. 8 is a bottom perspective view of the present invention with a mounted aerial ladder; and

FIG. 9 illustrates three prior art outrigger configurations.

### DETAILED DESCRIPTION OF THE INVENTION

The present invention generally relates to a vehicle leveling system and method using a combination outrigger and jack mount suitable for aerial ladder mounts. Such application allows greater flexibility and therefore greater usefulness of a vehicle over an increased variety of soil conditions and terrain.

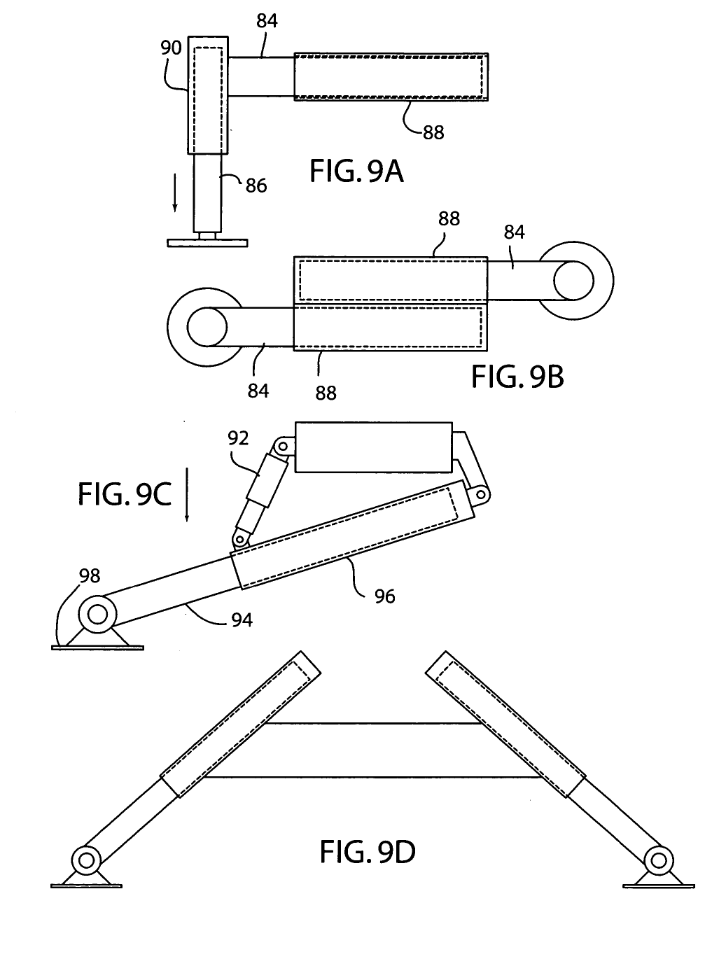

There are known in the art three types of leveling assemblies for leveling and stabilizing vehicles such as fire trucks with aerial ladders generally illustrated in FIG. 9. FIGS. 9a (side view) and 9b (top view) show an “out and down” or “H” outrigger 84 having a jack 86. In use, a pair of outriggers 84 slide out of an outrigger housing 88 using hydraulic means well known in the art. Next the jacks 86 are lowered from a jack housing 90 to the desired positions. FIG. 9c shows a side view an “underslung” configuration having a hydraulic means 92 to lower an outrigger arm 94 having a pad 98 from an outrigger housing 96. While this stores neatly under a vehicle when not in use, it does not effectively level a vehicle in adverse slope conditions. FIG. 9d illustrates an “A” frame configuration having outrigger 100 deployed from housing 102. This is an inefficient use of vehicle space, does not support or level heavy vehicles, and does not provide a wide range of leveling and outrigger stabilization.

The combined outrigger and jack mount feature of the present invention dependably allows greater range and flexibility in leveling a large vehicle such as a fire truck on a variety of surfaces while operating an aerial ladder. This is accomplished by incorporating a scissoring mechanism to an outrigger system that maintains the vehicle level in addition to the use of jacks. Thus, this configuration provides an even base from which the ladder is operated, while using limited vehicle space.

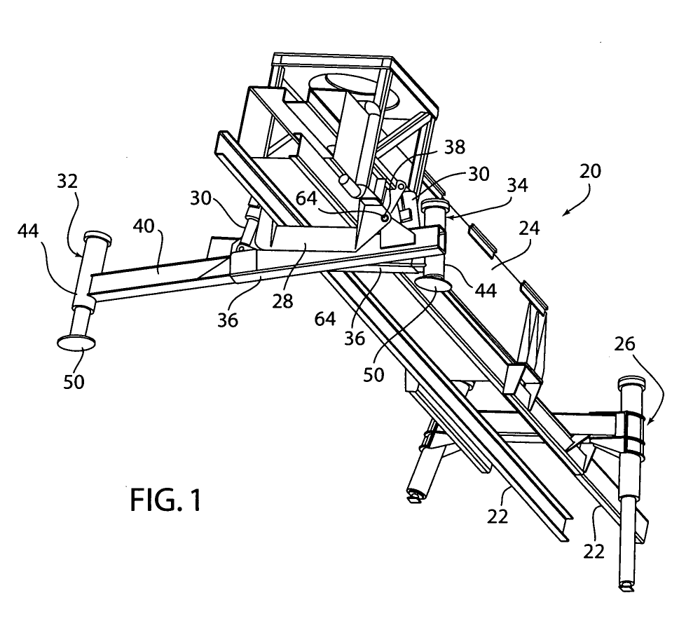

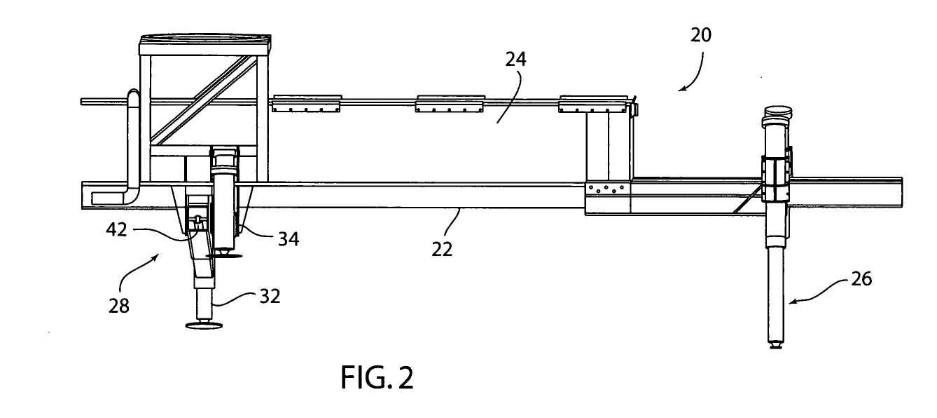

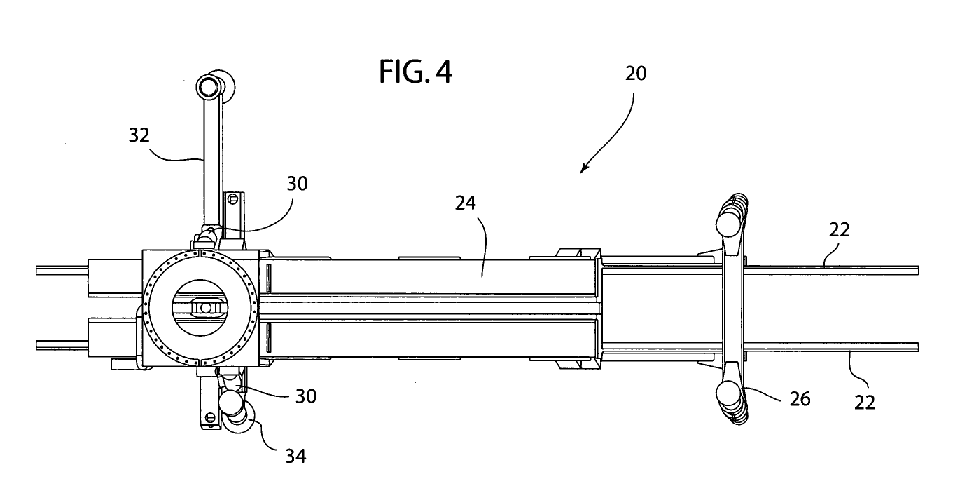

Referring now to the figures, FIGS. 1 through 4 illustrate a basic chassis configuration of an aerial fire truck and is generally indicated at 20. It should be noted that although the invention is described as part of an aerial fire truck, it could be applied to any vehicle requiring a level and secure base. Thus, it could apply to any self-propelled mobile work machine, for example, excavating equipment. The chassis as illustrated has frame rails 22 and a torque box 24. Torque box 24 is conventional to such applications and resists twisting of the frame while the ladder is in use. A prior art “A” frame leveling device is generally indicated at 26.

The outrigger superstructure 28 of the present invention, as shown and attached to chassis 20, has disposed within it a pair of outrigger units. In FIGS. 1 through 4, outrigger unit 32 is in an extended position ground engaging position, while outrigger unit 34 is in a retracted position. Outrigger units 32 and 34 extend from chassis frame rails 22 in a direction transverse to the longitudinal section of the vehicle. Units 32 and 34 are operable to elevate and stabilize the vehicle and include identical operating components and function in an identical manner.

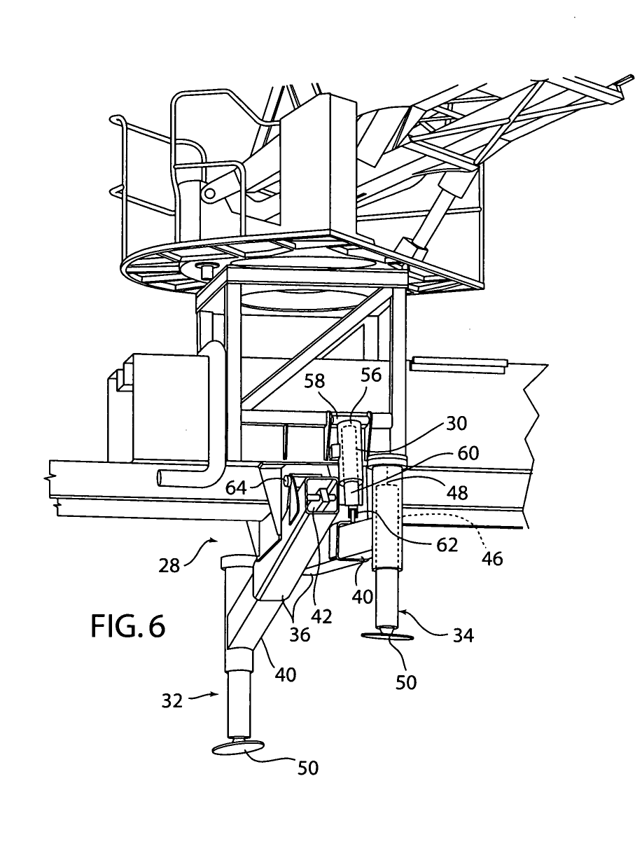

Each unit 32 and 34 has a leveling cylinder 30 using a two-directional, i.e., double acting hydraulic system well known in the art. In the preferred embodiment of the invention, movement of all cylinders is fluid actuated using a cylinder body and a cylinder rod. For example, shown in FIG. 6 is a cylinder 30 having a cylinder body 56 mounted to outrigger superstructure 28 by cylinder mount 58. Cylinder rod 60 is mounted to outrigger beam 40 by a cylinder rod mount 62. Double-acting hydraulic cylinders are the preferred form of linear actuators used in the practice of the invention, but other actuators, for example, screw or worm gear driven types can be substituted, as will be recognized by those skilled in the art.

As the rod 60 of leveling cylinder 30 extends, an outrigger extension beam housing 36 is pivoted from pivot point 38 and mounted by a pivot pin 64. Outrigger extension beam housing 36 is generally square and defines an open cavity. Pivot point 38 is on the side opposite leveling cylinder 30. Mounted and telescopically moveable within the open cavity of outrigger extension beam housing 36 is an extendable-retractable outrigger beam 40. An extension cylinder 42 within outrigger extension beam housings 36 is shown in FIG. 6 and is, again, well known in the art.

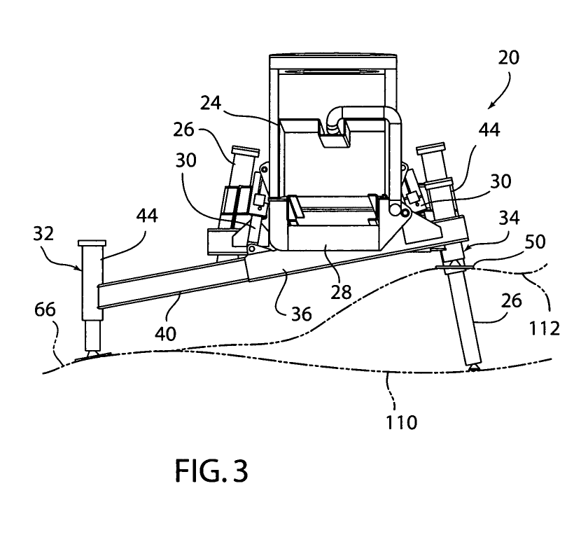

Attached to each outrigger beam 40 is a jack tower 44. As shown in FIG. 3, the jack tower 44 is not mounted perpendicular to outrigger beam 40 as is the case in prior art “out and down” configurations. Instead, it is mounted at an angle to allow jack tower 44 to be perpendicular to surface 110 when leveling cylinder 30 is extended. Mounted and telescopically moveable within each jack tower 44 is jack cylinder 46. Usually this angle of offset from the perpendicular will be in the range of about 5 degrees to 25 degrees the preferred angle being about 10 degrees. FIG. 3 also shows the range of surfaces (110 and 112) that may be experienced in the deployment of outriggers of the present invention to provide a stable platform for the work vehicle and its ladders, hoists or other attachments.

A jack tower extension cylinder 48 within jack tower 44 is shown in FIG. 6 and preferably uses double-acting hydraulic systems well known in the art. Pivotally mounted on each jack tower 44 is pad 50 to allow broad surface engagement with the load from jack tower 44.

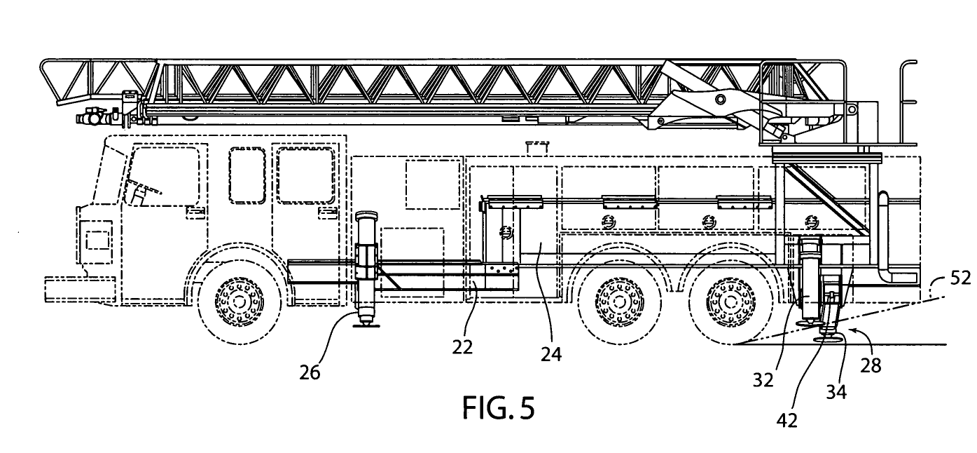

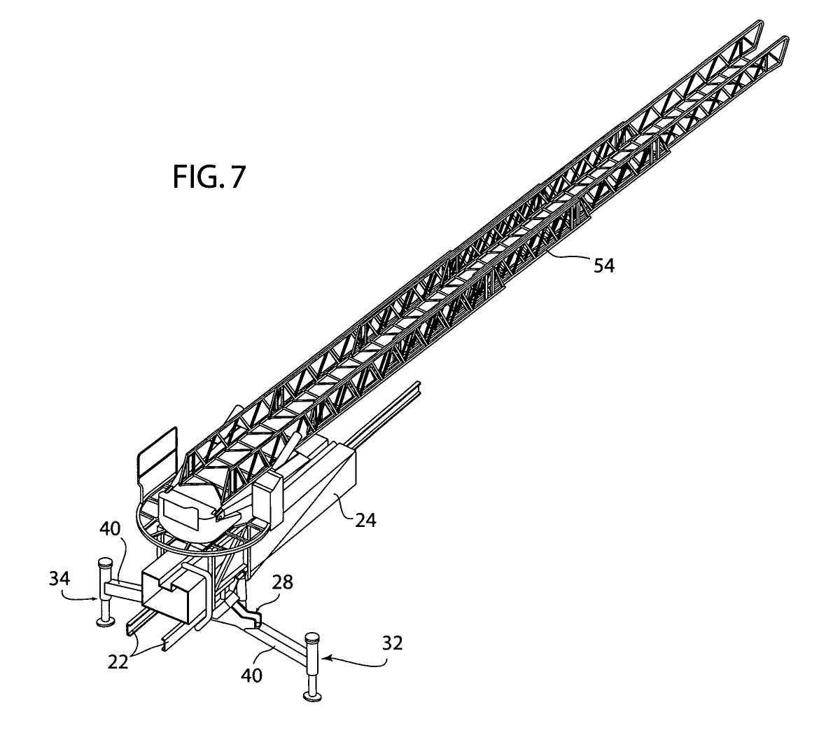

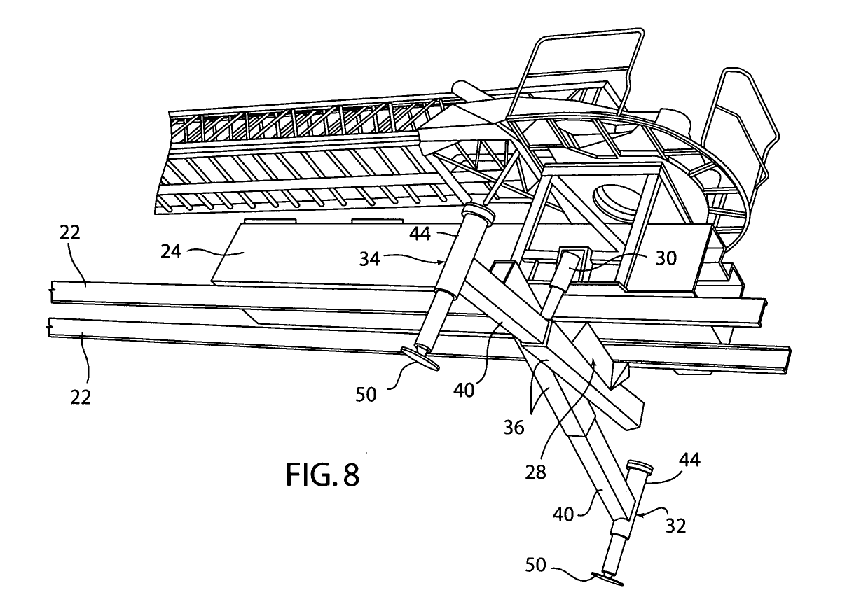

FIG. 5 illustrates the present invention outrigger system as part of a fire truck. The vehicle equipped with the present invention is of a size and weight such that it does not exceed the legal dimensional limits for over the road travel. The outriggers of the present invention in retracted position, maintain a proper ground clearance for the vehicle as illustrated by line 52. A minimum of 8 degree clearance angle is typically needed. FIGS. 7 and 8 show the present invention deployed to allow extension of a multi-section aerial ladder 54.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. An assembly adapted for use in an outrigger device for stabilizing a work vehicle, comprising:
an elongated housing having an open end and adapted to be pivotally attached to the vehicle;
an extendible-retractable beam telescopically fitted in said housing;
an actuator for extending and retracting said beam;
a jack tower affixed to an end of said beam, said jack tower including a first component affixed to said beam and a second extendible retractable component telescopically affixed to said first component; and
an actuator for extending and retracting said second component.

2. An assembly according to claim 1, wherein said second component has a ground engaging pad attached thereto.

3. An assembly according to claim 1, wherein said jack tower is affixed to said beam at an angle offset from 90 degrees.

4. An assembly according to claim 3, wherein said angle of offset is about 5 degrees to about 25 degrees.

5. An assembly according to claim 1, wherein each actuator comprises an independently actuatable double acting hydraulic cylinder.

6. An assembly according to claim 3, wherein said jack towers each comprise leveling cylinders and said second components comprise extendable-retractable rods telescopically fitted is said cylinders.

7. An assembly according to claim 1, wherein said housing is adapted to be pivotally attached to a first side of said vehicle and said beam extends beyond the opposite side of said vehicle.

8. An outrigger assembly for stabilizing a vehicle, comprising:
a pair of elongated support housings each adapted to be pivotally attached to said vehicle at a pivot point and each adapted to extend toward opposite sides of said vehicle from each other;
each housing having an open end having an extendible-retractable beam telescopically fitted therein;
an actuator for extending or retracting each beam;
a jack tower affixed to an end of each beam, said jack tower including a first component affixed to said beam and a second extendible retractable component telescopically affixed to said first component;
an actuator for extending and restricting said second component; and
an actuator for pivoting each housing about said pivot point.

9. An assembly according to claim 8, wherein each actuator comprises an independently actuatable double acting hydraulic cylinder.

10. An assembly according to claim 8, wherein said second component has a ground engaging pad pivotally attached thereto.

11. An assembly according to claim 8, wherein said jack tower is affixed to said beam at an angle offset from 90 degrees.

12. An assembly according to claim 11, wherein said angle of offset is about 5 degrees to about 25 degrees.

13. An assembly according to claim 8, wherein said jack towers each comprise hydraulic cylinders and said second components comprise extendable-retractable rods telescopically fitted is said cylinders.

14. An assembly according to claim 8, wherein said housing is adapted to be pivotally attached to a first side of said vehicle and said beam extends beyond the opposite side of said vehicle.

15. An assembly according to claim 8, wherein said vehicle comprises a fire engine fitted with an extendable aerial ladder.
